(19) United States
(12) Patent Application Publication
(10) Pub. No.: US 2008/0263944 A1
(43) Pub. Date: Oct. 30, 2008

(54) Support for potted plants

(76) Inventor: Charles E. McGaughey, Kansas City, MO (US)

Correspondence Address: LAW OFFICE OF JOHN C. MCMAHON, P.O. BOX 30069, KANSAS CITY, MO, 64112, US

(21) Appl. No.: 12/148,375

(22) Filed: Apr. 18, 2008

Related U.S. Application Data
(60) Provisional application No. 60/926,074, filed on Apr. 24, 2007.

(51) Int. Cl. A01G 9/12; A01G 9/02

(52) U.S. Cl. 47/70

(57) ABSTRACT

A plant support having a base and a riser extending upward from the base. The base is received in a pot or the like and soil placed thereon to stabilize the base. The riser extends above the soil to support a plant growing in the soil.

### CROSS-REFERENCE TO RELATED APPLICATION

This application claims the benefit of U.S. Provisional Patent Application Ser. No. 60/926,074, filed Apr. 24, 2007, incorporated by reference herein.

### BACKGROUND OF THE INVENTION

The present invention is directed to a support structure to be utilized with plants, especially potted plants to support vines, non self supporting vegetables and the like.

Indoor winter gardens are becoming increasingly popular. For example, the growing of tomatoes in five gallon pails under a growth light is becoming increasingly more common. Once of the problems with growing such plants is that many are non self supporting or provide better growth and quality of fruit, vegetables or flowers, if supported.

Such growth of plants works well when the full grown plant is small and does not require substantial support. However, many plants of this type are bulky, heavy or otherwise hard to support. Oftentimes support is provided by insertion of a stick or stake into the potting soil in which the plant is planted. Unfortunately, this does not work well for the large and bulky plants because the potting soil (or even regular soil) does not provide good support for such stakes or supports. At some time, the plant becomes sufficiently large that it puts enough pressure on the stake such that the stake becomes partly or fully unseated with the result that plant at least partially collapses.

Consequently, it is desirable to provide a staking system for plants, especially plants in pots or buckets, that can provide a stable support for even large and bulky plants, such as fully grown tomato plants which may grow to six feet high and extend substantially laterally.

### SUMMARY OF THE INVENTION

A support for growing plants, especially plants grown in potting soil in pots, buckets, pails or the like. The support includes at least one elongate riser or shaft that operably vertically extends through and above the soil for supporting a respective plant. The shaft is frictionally or permanently secured to a base that is sized and shaped to be spread and be located generally in a horizontal alignment in the bottom of the associated pot, bucket or the like. In some instances, the structure could also be placed in the ground with the base located below the principal root structure of the plant.

Consequently, preferably the base is a generally circular structure that is comparatively shorter than wide. The spread of the base with soil and other material on the base provides leverage and stability to support the shaft in an upright position and resist tilting of the shaft due to the weight or position of the plant being supported. The base preferably has a diameter slightly smaller than the bottom of the pot that receives the base. For example, the pot may have an eighteen inch diameter and the base approximately a seventeen and a half inch diameter and a one half inch height. Preferably, the base includes feet or spacers to support the base above the bottom of the pot to allow water flow therebetween.

The base includes at least one vertical bore to receive the shaft. Preferably, the shaft fits frictionally in the bore. Furthermore, the base may include a large number of alternative bores, allowing the shaft to be located in different positions relative to the base and pot. That is, the shaft may be centrally located or located near the periphery of the bottom of the pot or in between depending on the desire of the grower and the type of plant.

Still further, the shaft may vary substantially with respect to the plant being grown. In some instances a single shaft is satisfactory to support the plant and in other cases multiple shafts can be secured to the base. The length of the shaft or shafts can be varied for the plants to be grown. Still further, a single shaft or multiple vertical shafts can be used with horizontal cross bars secured to the vertical shafts to produce various structures including trellise like structures.

In use, the support is utilized by placement of the base with shaft secured thereto in soil below the expected position of a plant. When used in a pot, the base is positioned to sit on or near the bottom of the pot. Normally, a layer of an inch or so of gravel is placed above and on the base. Then the pot is filled with soil within which the plant is planted. The shaft extends above the plant and pot to support the plant, as the plant grows.

### Objects and Advantages of the Invention

Therefore, the objects of the present invention are: to provide a support for growing plants, especially plants grown in pots, buckets or the like; to provide such a support comprising a base that is positioned to horizontally extend across the bottom of a pot or the like and a shaft that is frictionally or permanently secured or attached to the base and such that the shaft extends above the pot to support the growing plant; to provide such a support that allows for varying position of the shaft relative to the pot; to provide such a support where the base effectively provides a substantial lower lever or pivot arm that resists movement of the shaft relative to the receiving pot or the like to provide better support to a respective plant; to allow such a support that provides for variance in number and related cross structure of the shaft to support different types of plants; and to provide such a support that is inexpensive to produce, easy to use and especially well adapted to the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a front elevational view of a plant support in accordance with the present invention, illustrated in conjunction with a pot, gravel, potting soil and a plant, with portions broken away to illustrate structure thereof.

FIG. 2 is a perspective view of the plant support.

FIG. 3 is a bottom plan view of the plant support.

FIG. 4 is a top plan view of the plant support.

FIG. 5 is a fragmentary and exploded view of the plant support showing a base being joined to a riser thereof.

FIG. 6 is a perspective view of a first modified plant support in accordance with the invention.

FIG. 7 is a perspective view of a second modified plant support in accordance with the invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Shown in the drawings is a plant support in accordance with the present invention generally identified by the reference numeral 1. The support 1 includes a base 5 and a riser 6. The support 1 is used in conjunction with a pot 7 with a bottom 8 and sidewall 9.

The base 5 has upper and lower surfaces 10 and 11 with a circular side 12. In the illustrated embodiment, the pot 7 is round. It is foreseen that the pot 7 can be any of various types of devices for holding potted plants including flower pots, five gallon buckets, pails and the like. Consequently, in this embodiment the base 5 is round with a diameter slightly smaller than the pot sidewall 9 that expands vertically outward slightly, so that the base 5 easily slides into the pot 7 such that the base lower surface 11 is closely spaced relative to the pot bottom 8. In this embodiment, the base 5 is generally cylindrically shaped with a relatively short height compared to diameter. It is foreseen that in some embodiments the base may be square, rectangular or otherwise shaped to conform to the shape of the receiving structure or may be any shape that spreads horizontally outward, if for use in the ground.

The base 5 has a plurality of feet 15 that are located on the base lower surface 11 to slightly space the lower surface 11 from the pot bottom 8 to allow flow of water therebetween.

The base 5 further includes at least one opening, aperture, or bore 17 that extends at least partially through the base 5 from the base upper surface 10. In the illustrated embodiment there are a plurality of spaced vertical pass through bores 17 passing completely through the base 5. The bores 17 are preferably spaced from each other and located at multiple locations across the base upper surface 10.

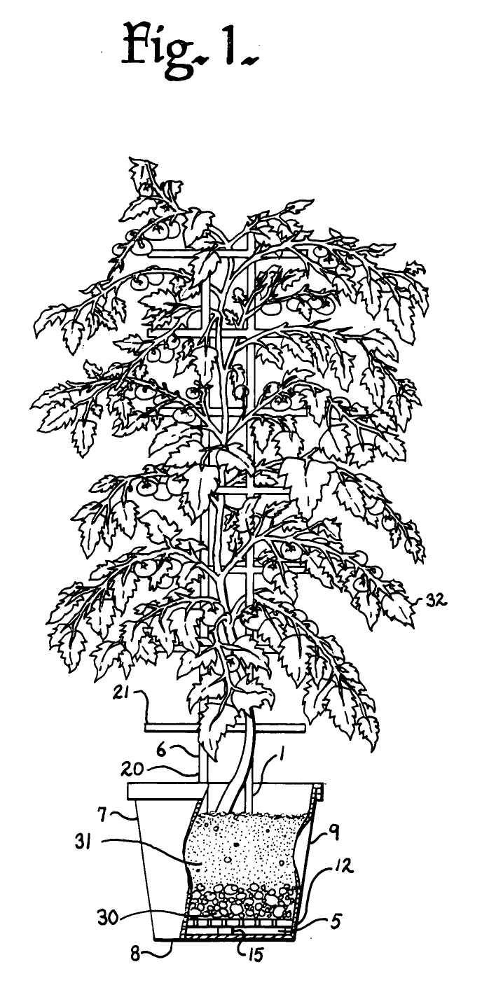

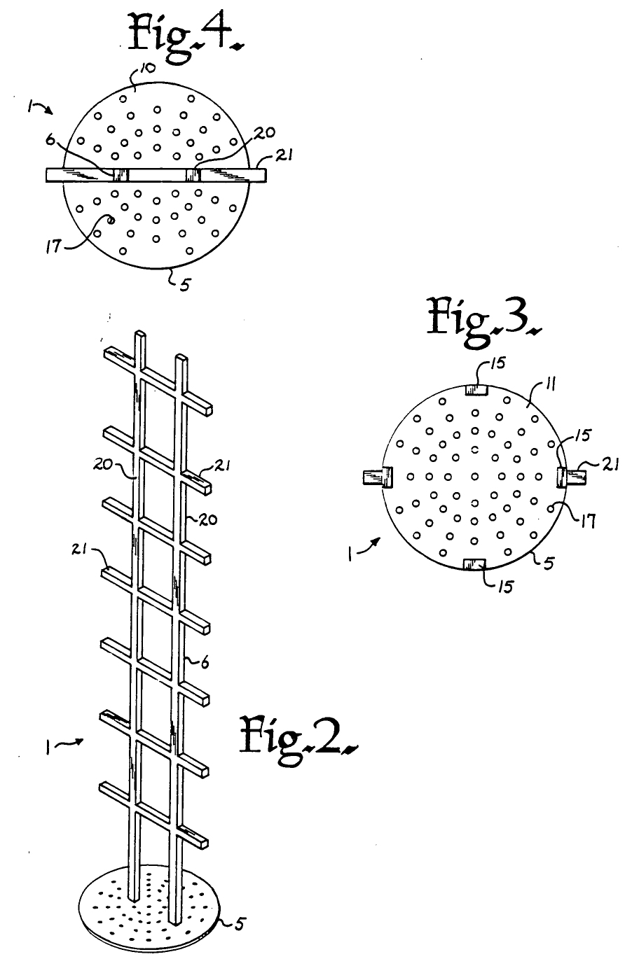

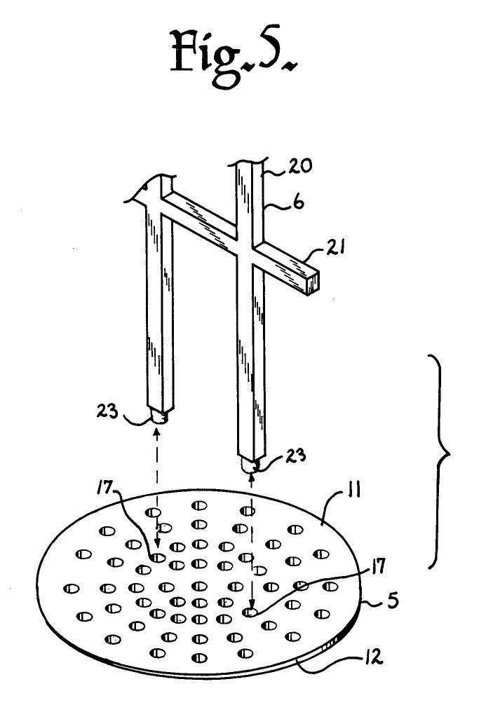

In the embodiment shown in FIGS. 1 to 5 the riser 6 includes a pair of parallel spaced, vertically, elongate rods or shafts 20 fixedly joined together by elongate and horizontally configured connecting bars 21 that are vertically spaced and extend outward on either side of the shafts 20.

The shafts 20 and bars 21 are fixedly secured together and preferably integral to produce a trellise like structure for support of plants. located at the bottom end of each shaft 20 and extending axially therefrom is a peg 23 that is sized and shaped to be received in one of the base bores 17. FIG. 5 shows the pegs 23 being placed in a pair of the base bores 17. The pegs 23 may be frictionally held in the bore 17 or alternatively may be glued therein. In some embodiments it is foreseen that the base and riser may be molded integrally thereby eliminating the need for the pegs 23 and bores 17; however, the plurality of bores 17 provides the advantage that the riser 6 may be selectively positioned in different configurations relative to the base 5 and pot 7.

Shown in FIG. 1 is the support 1 positioned in the pot 6. In this illustration, a layer of gravel 30 is positioned over the base 5 which is then covered to near the top of the pot 7 with potting soil 31. A plant, in this case a tomato plant 32, is planted in the soil 31 and extends upward along side and intertwined with the riser 6. If the plant 32 does not become self supported by the riser 6, ties of various types may be used to secure branches of the plant 32 to various shafts 20 and bars 21 to support the plant 6.

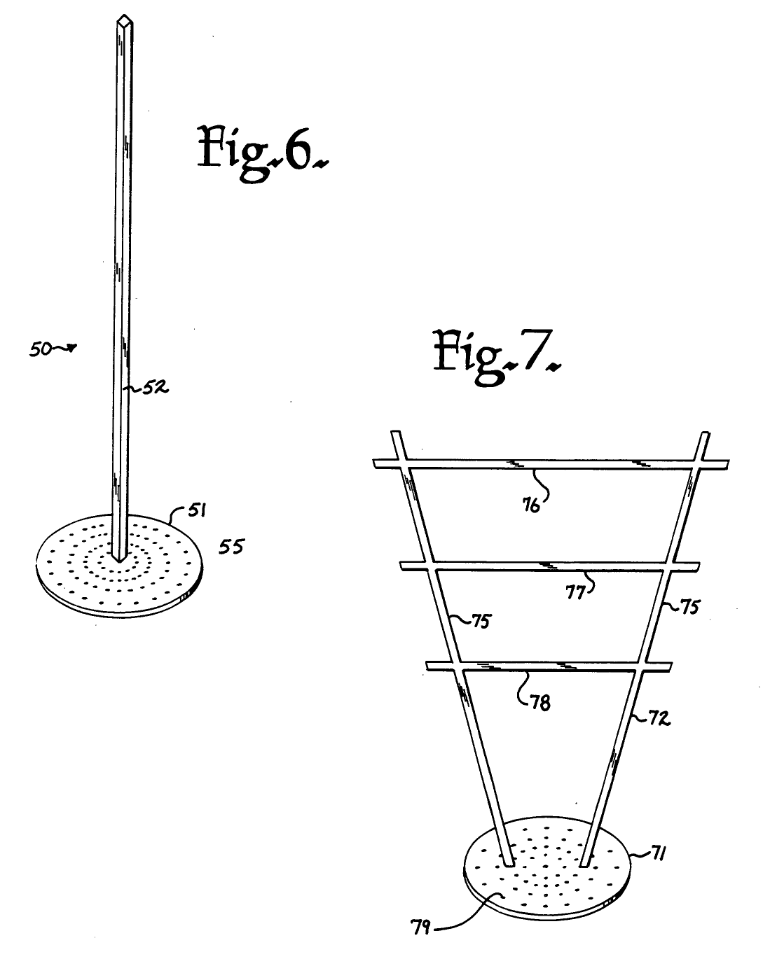

Illustrated in FIG. 6 is a modified plant support that is generally indicated by the reference numeral 50. The support 50 includes a base 51 and a riser 52. The riser 52 is secured in one of a plurality of bores 55 in the base in the manner of support 1. The support 50 is used in the same way as support 1.

Shown in FIG. 7 is a second modified plant support that is generally indicated by the reference numeral 70. The support 70 includes a base 71 and a riser 72. The riser 72 includes a pair of upwardly diverging and spaced shafts 75 joined by three elongate bars 76, 77 and 78 that extend outwardly on either side of the shafts 75. The shafts 75 each have a non axially aligned peg that extends from a bottom of the respective shaft 75 and that is each fixedly received in a selected one of a plurality of bores 79 in the base 71. The support 70 is used in the same manner as support 1.

It is to be understood that while certain forms of the present invention have been illustrated and described herein, it is not to be limited to the specific forms or arrangement of parts described and shown.

What is claimed and desired to be secured by Letters Patent is as follows:

1. A plant support comprising:
a) a base having a width, depth and height wherein said width and depth are substantially greater than said height;
b) a riser fixably joinable to said base so as to extend upwardly therefrom;
c) whereby said support is sized and shaped such that said base is adapted to be placed below soil receiving a plant and said riser extends above the soil to operably support the plant during growth.

2. The support according to claim 1 wherein:
a) said base is circular.

3. The support according to claim 1 wherein:
a) said base includes a plurality of bores; and
b) said riser includes at least one peg to be fixedly received in a selected bore.

4. The support according to claim 3 wherein:
a) said peg is sized and shaped to be frictionally received in any selected one of said bores.

5. The support according to claim 1 including wherein:
a) said base includes a plurality of feet to operably space the base from a supporting surface.

6. The support according to claim 1 wherein:
a) said riser includes a single upright elongate shaft.

7. The support according to claim 1 wherein:
a) said base comprises a pair of upright shafts interconnected by at least one horizontal bar.

8. The support according to claim 7 wherein:
a) said shafts diverge outward relative to each other from a bottom to a top thereof so as to operably form a trellise.

9. A plant support system comprising:
a) a pot;
b) a plant support having a base with substantially greater width and depth as compared to height and a riser extending upward from said base; said support being located in said pot so that said base is located near a bottom of the pot and the riser extends above the pot; and
c) soil placed within said pot and covering said base.

10. The system according to claim 9 including:
a) a plant that is operably grown in said soil and supported by said support.

11. The system according to claim 9 including:
a) a layer of gravel between said base and said soil.

12. The system according to claim 9 wherein:
a) said base is circular with a diameter and said pot is circular with a diameter; wherein said base diameter is sized to allow said base to snugly fit within said pot.

13. The system according to claim 9 wherein:
a) said base has a plurality of pass through bores in spaced relationship to one another; and
b) said riser includes a pair of shafts interconnected by cross bars and each shaft having a lower peg that is sized and shaped to frictionally be received in selected bores, such that the riser move be selectively positioned at different locations relative to the base.

14. The system according to claim 13 wherein:
a) said base includes a plurality of feet on an underside thereof to operably space the base from a bottom of the pot.
